(19) United States
(12) Patent Application Publication
(10) Pub. No.: US 2015/0323136 A1
(43) Pub. Date: Nov. 12, 2015

(54) Pressure Vessel Closure Apparatus and Method

(71) Applicant: Pentair Filtration Solutions, LLC, St. Paul, MN (US)

(72) Inventor: Matthew Southam, Glen Alpine (AU)

(21) Appl. No.: 14/705,909

(22) Filed: May 6, 2015

Related U.S. Application Data
(60) Provisional application No. 61/989,097, filed on May 6, 2014.

(51) Int. Cl. F17C 13/06

(52) U.S. Cl. CPC F17C 13/06; F17C 2209/22; F17C 2209/234

(57) ABSTRACT

Embodiments of the invention provide a pressure vessel closure apparatus for a pressure vessel having a shell wall, a removable end cap, and an internal retaining groove along an interior surface of the shell wall. The retaining member can include a main-portion outer profile and an end-portion outer profile. The end-portion outer profile can deviate from the main-portion outer profile in order to provide a clearance between the interior surface of the shell wall and the retaining member for the insertion of the retaining member into the retaining groove. A stop can be secured in place with respect to the end cap or the shell wall in order to retain the retaining member within the retaining groove. The retaining member, as retained within the retaining groove by the stop, can retain the end cap within the pressure vessel when the pressure vessel is pressurized.

### RELATED APPLICATIONS

This application claims priority under 35 U.S.C. §119 to U.S. Provisional Patent Application No. 61/989,097 filed on May 6, 2014, the entire contents of which are incorporated herein by reference.

### BACKGROUND

In various systems, including various cleaning systems, the use of pressurized fluids (e.g., liquids or gases) can require the use of a pressure vessel. Pressure vessels can take a variety of forms, but generally provide an enclosed chamber with sufficient strength to safely retain fluid up to a particular rated pressure. Through suitable selection of material type, wall thickness and so on, various walls of the enclosed chamber of a pressure vessel can be designed to support various rated pressures as needed. For example, conventional engineering analyses can be used to ensure that a cylindrical shell of a cylindrical pressure vessel is sufficiently thick to sustain a rated pressure. Where end caps or other similar features are needed, however, other considerations can also be important. For example, even if an end cap itself is designed with sufficient strength (e.g., sufficient thickness) to survive a particular rated pressure, the connection between the end cap and the main body of the pressure vessel (e.g., a cylindrical shell) must also be sufficiently strong to contain the rated pressure. If such a connection is not properly designed and implemented, pressurization of the vessel can cause vessel failure through the failure of the connection, even if the end cap itself remains intact.

In some conventional designs, welded joints can be used to provide a connection between an end cap (or similar feature) of a pressure vessel and the body of the pressure vessel. When properly executed, welded joints can provide a relatively strong connection between components, and can be suitable for pressure vessels of various rated pressures. However, welding can be difficult to execute in certain environments or locations, can require highly skilled technicians, and may not be suitable for certain pressure vessels. Further, various standards and requirements for satisfactory welds (e.g., under ASME or PED pressure vessel codes) can introduce significant complexity and cost to manufacturing processes.

Non-welded connections for pressure vessels may not be subject to the same standards or requirements as welded connections, can be implemented in various environments or locations, and can sometimes be implemented by less highly skilled technicians. Accordingly, non-welded connections can provide attractive alternatives to welded connections from the perspective of manufacturing complexity and cost. However, various existing non-welded connections for pressure vessels exhibit significant complexity, or are relatively susceptible to incorrect installation and other issues. For example, some conventional non-welded connection designs use circlips seated within annular grooves of a pressure vessel shell in order to secure an end cap within the shell. In many such designs, a circlip are deformed during installation in order to be seated within a retaining groove, then allowed to spring into place within the grooves to hold the end cap in place. Accordingly, the circlips used must provide a relatively large degree of elasticity without plastic deformation. This requirement, however, can limit the potential thickness of the circlips and, accordingly, the circlips' strength in retaining the end cap. Further, it can be possible for a circlip to appear properly installed even though the circlip is not fully seated within the annular groove. Where the circlip is not fully seated, the strength of the joint can be significantly reduced.

Accordingly, it may be useful to provide a pressure vessel closure apparatus and installation method that can allow for relatively easy installation of the closure apparatus, while also providing significant retention strength and avoiding a false appearance of proper installation.

### SUMMARY

Some embodiments of the invention provide a pressure vessel closure apparatus for a pressure vessel having a shell wall, a removable end cap, and an internal retaining groove along an interior surface of the shell wall. First and second retaining members can include respective main portions, each with a main-portion outer profile configured to seat within the internal retaining groove. The retaining members can further include respective end portions, each with an end-portion outer profile. Each end-portion outer profile can deviate from the respective main-portion outer profile to provide a clearance between the interior surface of the shell wall and the respective retaining member.

A stop can be configured for insertion between the first and second end portions when the first and second retaining members are seated in the internal retaining groove. The stop can include an attachment device for securing the stop with respect to at least one of the end cap and the shell wall. The stop can engage the first and second end portions of the first and second retaining members, when the stop is inserted between the first and second end portions and secured with respect to the at least one of the end cap and the shell wall, in order to retain the first and second retaining member within the internal retaining groove. When retained within the internal retaining groove by the stop, the first and second retaining members can engage the internal restraining groove to retain the end cap within the pressure vessel.

Some embodiments of the invention provide another pressure vessel closure apparatus for a pressure vessel having a shell wall, a removable end cap, and an internal retaining groove along an interior surface of the shell wall. A first retaining member can include a first main portion with a first main-portion outer profile, and first and second end portions at opposite ends of the first outer profile. The first and second end portions can include first and second end-portion outer profiles, respectively, that deviate from the first main-portion outer profile. A second retaining member can include a second main portion with a second main-portion outer profile, and third and fourth end portions at opposite ends of the second outer profile. The third and fourth end portions can include third and fourth end-portion outer profiles, respectively, that deviate from the second outer profile. First and second stops can be configured to attach to at least one of the shell wall and the end cap.

The first and second retaining members can define a first gap between the first and third end portions and a second gap between the second and fourth end portions, when the first and second main portions are seated in the retaining groove. The first and second stops can secure the first and second retaining members within the retaining groove, when the first and second stops are inserted into the first and second gaps, respectively, and attached to the at least one of the shell wall and the end cap.

Some embodiments of the invention provide a method for installation of a pressure vessel closure. An end cap of a pressure vessel can be inserted into an open end of a shell of the pressure vessel until the end cap is seated against an internal shoulder of the shell with an outer face of the end cap opposite an internal retaining groove of the shell from the open end of the shell A first main-portion outer profile of a first retaining member can be inserted into the retaining groove such that first end-portion outer profiles of the first retaining member are disposed outside the retaining groove to define first clearances between the shell wall and the first retaining member, and such that first and second ends of the first end-portion outer profiles are offset from a centerline of the end cap towards the first main-portion outer profile. A second main-portion outer profile of a second retaining member can be inserted into the retaining groove such that second end-portion outer profiles of the second retaining member are disposed outside the retaining groove to define second clearances between the shell wall and the second retaining member, and such that third and fourth ends of the second end-portion outer profiles are offset from the centerline of the end cap towards the second main-portion outer profile.

A first stop can be inserted between the first end of the first end-portion outer profile and the third end of the second end-portion outer profile, with a first tongue of the first stop extending into the retaining groove. A second stop can be inserted between the second end of the first end-portion outer profile and the fourth end of the second end-portion outer profile, with a second tongue of the second stop extending into the retaining groove. The first and second stops can be secured to at least one of the shell wall and the end cap to secure the first and second retaining members within the retaining groove.

### DESCRIPTION OF THE DRAWINGS

FIG. 1 is a perspective view of a pressure vessel with a pressure vessel closure apparatus, according to one embodiment of the invention;

FIG. 2A is a perspective view of a shell of the pressure vessel of FIG. 1;

FIG. 2B is a cross-sectional view of the shell of FIG. 2A;

FIGS. 3A through 3C are perspective, end, and side views, respectively, of an end cap of the pressure vessel of FIG. 1;

FIGS. 4A through 4C are perspective, end, and side views, respectively, of a retaining member of the pressure vessel closure apparatus of FIG. 1;

FIGS. 5A and 5B are perspective views of a stop of the pressure vessel closure apparatus of FIG. 1;

FIGS. 5C through 5E are top, front, and side views, respectively, of the stop of FIGS. 5A and 5B;

FIG. 6 is a cross-sectional view of the pressure vessel of FIG. 1, showing the installation of the end cap of FIGS. 3A through 3C;

FIG. 7A is an end view of the pressure vessel of FIG. 1, showing the installation of a first retaining member configured as in FIGS. 4A through 4C;

FIG. 7B is an enlarged view of area A of FIG. 7A;

FIGS. 8 and 9 are end views of the pressure vessel of FIG. 1, further showing the installation of a second retaining member configured as in FIGS. 4A through 4C;

FIG. 10A is an end view of the pressure vessel of FIG. 1, showing the installation of the stops of FIGS. 5A through 5E;

FIG. 10B is an enlarged view of area B of FIG. 10A;

FIG. 11A is an end view of the pressure vessel and pressure vessel closure apparatus of FIG. 1, as fully installed;

FIG. 11B is a sectional view of the pressure vessel and pressure vessel closure apparatus taken along line C-C of FIG. 11A;

FIGS. 12A and 12B are perspective and end views, respectively, of another pressure vessel and pressure closure apparatus; and

FIGS. 13A and 13B are perspective and end views, respectively, of still another pressure vessel and pressure closure apparatus.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Also, unless otherwise limited or defined, descriptions specifying geometrical relationships such as “radially outer,” “circumferentially beyond,” and the like, are used to provide a general frame of reference and may not necessarily imply a fully circular (or cylindrical) geometry.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives which fall within the scope of embodiments of the invention.

Generally, the disclosed pressure vessel closure apparatus can be used to retain end caps in pressure vessels that have internal retaining grooves. In some embodiments, the disclosed apparatus includes at least two retaining members, each exhibiting a similar radially outer profile. Main portions of the respective outer profiles can be configured to be generally complimentary to the retaining groove of the relevant pressure vessel, such that the retaining members can be inserted within the retaining groove over those portions of the outer profiles. For example, main portions of the outer profiles of the retaining members can be configured as generally circular profiles, with a radius of curvature generally equal to a radius of curvature of the retaining groove (i.e., with the main portions of the outer profile generally congruent to the retaining groove). In this way, for example, the outer profiles of the retaining members can be firmly seated against a radially outer wall of the retaining groove during installation.

End portions of the retaining members can be configured with outer profiles that deviate from the main portions of the outer profiles. For example, where the main portions of the outer profiles are configured with generally circular profiles with a first radius of curvature, end portions of the outer profiles can be configured with circular profiles having a second, smaller radius of curvature. The deviation in the outer profiles at the end portions of the retaining members can provide a clearance between an inner wall of the pressure vessel shell and the end portions of the retaining members, such that the retaining members can be inserted into the retaining groove without significant deformation.

The retaining members can be configured to collectively extend over less than the entire circumference of a retaining groove, when the retaining members are inserted into the retaining groove, such that gaps are provided between adjacent end portions of the retaining members. Stops can be configured for insertion into these gaps, in order to retain the retaining members within the retaining groove. The stops can be configured to engage the end cap of the pressure vessel, as well as the retaining members and the retaining groove, such that the stops can provide retaining force to the end cap itself, as well as to the retaining members.

In order to install the disclosed apparatus, an end cap can be inserted into a pressure vessel. A first retaining member can be seated against the end cap, and a main portion of the first retaining member slid into a retaining groove of the pressure vessel, such that ends of the first retaining member do not extend to a centerline of the end cap. With the first retaining member seated in retaining groove, a second retaining member can be seated against the end cap, with ends of the second retaining member generally aligned with ends of the first retaining member. A main portion of the second retaining member can be slid into the retaining groove opposite the main portion of the first retaining member, such that ends of the second retaining member also do not extend to the centerline of the end cap and gaps are formed between adjacent ends of the first and second retaining member. A respective stop can be inserted into each gap, with tongues of the stops extending into the retaining groove. When the vessel is pressurized, the stop can accordingly retain the retaining members within the retaining groove, with the retaining members engaging the retaining groove and the end cap to retain the end cap in the pressure vessel. In some embodiments, the stop can contact the end cap when the stop is inserted between the retaining members, in order to further retain the end cap in the pressure vessel.

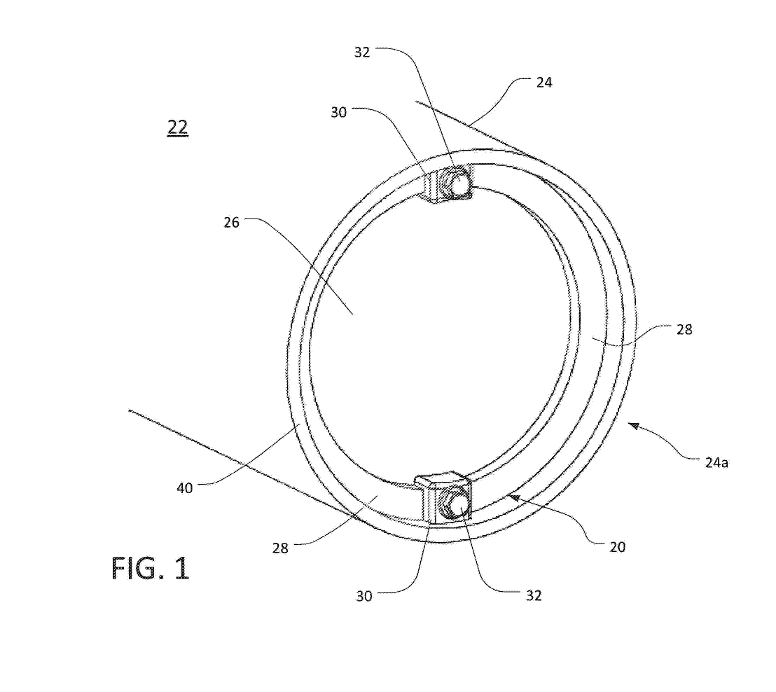

FIG. 1 illustrates an example pressure vessel closure apparatus 20 according to one embodiment of the disclosure. In the example depicted, the closure apparatus 20 is installed on a cylindrical pressure vessel 22 with a generally cylindrical shell 24 and generally cylindrical end cap 26. It will be understood, however, that other configurations of the pressure vessel 22 may be possible. Various example dimensions discussed herein may refer to a configuration in which the pressure vessel 22 is a six-inch pressure vessel. Again, it will be understood that other configurations may be possible.

As also discussed below, the closure apparatus 20 includes a set of retaining members 28, each exhibiting a generally annular profile over at least a portion of the retaining members 28. The retaining members 28 can be inserted into a generally annular groove (not shown in FIG. 1) around the interior of the shell 24 such that part of each retaining members 28 is contained by the groove and part of each retaining members 28 extends outside of the groove. Accordingly, during pressurization of the pressure vessel 22, the retaining members 28 can contact the end cap 26 and the groove to retain the end cap 26 within the shell 24 upon pressurization of the vessel 22. A set of stops 30 can be secured to the end cap 26 (or another feature) by bolts 32 (or various other attachment devices) in order to hold the retaining member 28 in place within the annular groove. In some embodiments, the stops 30 may also help to directly retain the end cap 26 within the shell 24.

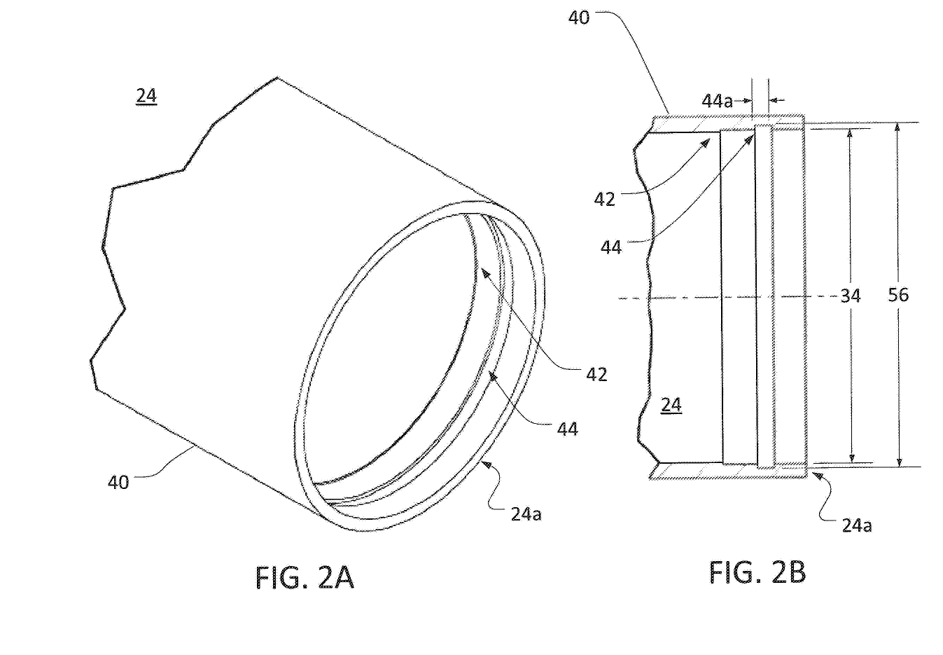

Referring also to FIGS. 2A and 2B, the shell 24 can include a cylindrical side wall 40 of appropriate thickness to contain the rated pressure of the pressure vessel 22. Near an open end 24a of the shell 24, an inner surface of the side wall 40 can be machined (or otherwise formed) with a shoulder 42 having a characteristic radially outer diameter 34. Between the shoulder 42 and the open end 24a, an annular groove 44 can also be provided, the groove 44 having a width 44a and a characteristic diameter 56 at a radially outer circumference of the groove 44. The diameter 56 of the groove 44 can be larger than the diameter 34 of the shoulder 42, such that the groove 44 extends farther into the interior of the side wall 40 than the shoulder 42. In certain embodiments, the portion of the interior of the side wall 40 between the shoulder 42 and the open end 24a, except for the groove 44, can generally exhibit the same characteristic diameter as the outer diameter 34 of the shoulder 42. In this way, for example, the end cap 26 (not shown in FIGS. 2A and 2B) can be smoothly inserted into the open end 24a of the shell 24 until the end cap 26 is seated against the shoulder 42.

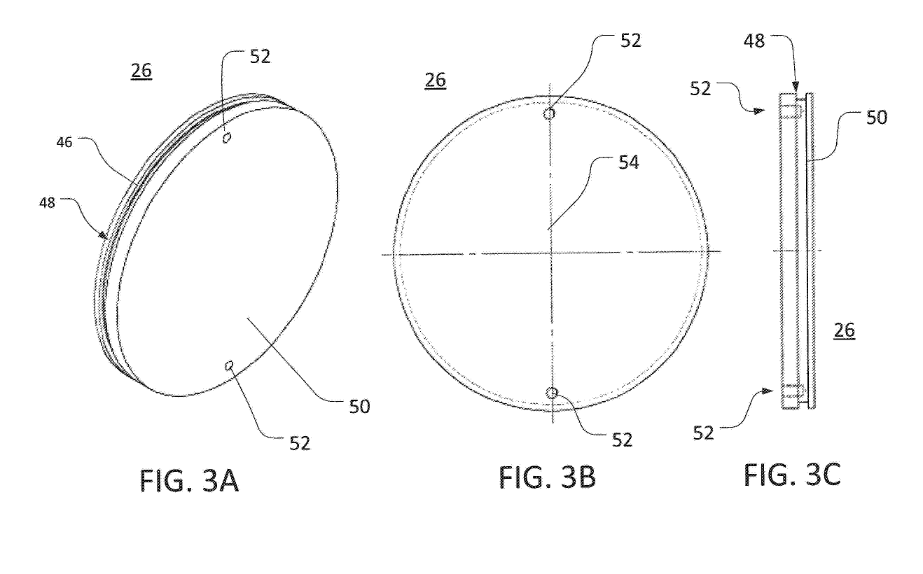

Referring also to FIGS. 3A through 3C, the end cap 26 is depicted from various perspectives. In certain embodiments, the end cap 26 can include a seal of various configurations, in order to prevent escape of pressurized fluid from the pressure vessel 22. For example, an annular groove 48 can be machined (or otherwise formed) along the radially outer circumference of the end cap 26 and an o-ring 46 or other seal can be seated within the groove 48. On an outer face 50 of the end cap 26 (i.e., the face of the end cap 26 that faces the open end 24a of the shell 24 when the end cap 26 is properly installed) can include two holes 52 (or other features) to receive the bolts 32 of the closure apparatus 20. In some embodiments, the two holes 52 can be blind, tapped holes into which the bolts 32 can be inserted to retain the stops 30 in place (see also FIG. 3B). In other embodiments, other attachment devices can be used to retain the stops 30, including attachment devices on other components (e.g., on the shell 24).

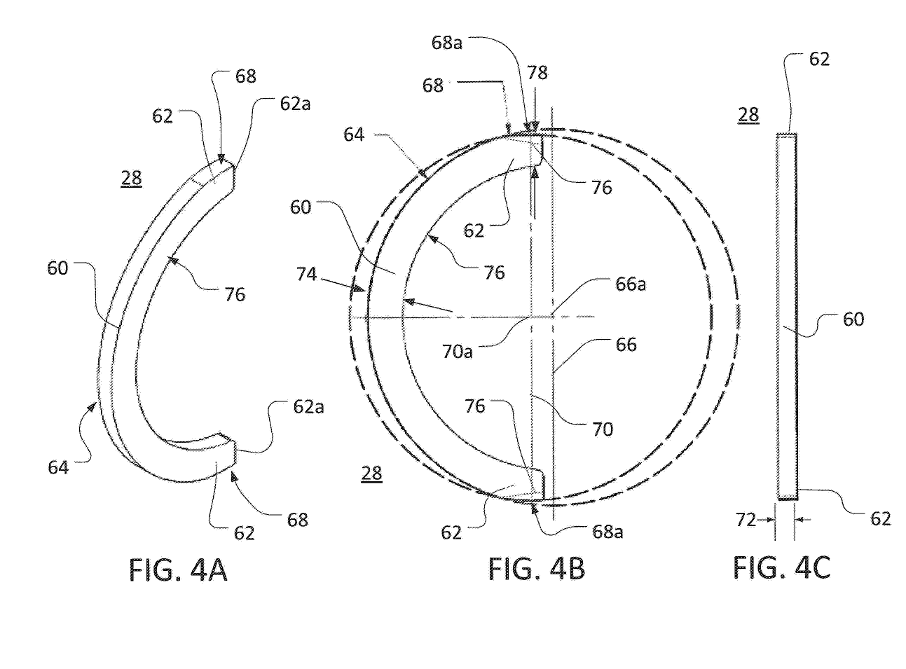

Referring also to FIGS. 4A through 4C, an example configuration of the retaining members 28 is depicted. In order to seat securely and firmly within the annular retaining groove 44 of the shell 24, each of the retaining members 28 can be formed with an extended main portion 60 having an outer profile 64 that generally traces an arc of circle having a characteristic diameter 66 (and a corresponding radius of curvature) and a center 66a. In certain embodiments, the characteristic diameter 66 can be substantially the same as (or can be only slightly smaller than) the characteristic diameter 56 of the retaining groove 44, such that the outer profile 64 is generally congruent with a corresponding arc of the groove 44. In this way, the outer profile 64 of the main portion 60 of the retaining members 28 can be seated securely and firmly within the retaining groove 44 when the retaining members 28 are installed as part of the closure apparatus 20.

In order to facilitate installation of the retaining members 28, each retaining member 28 can also include one or more end portions 62, each having a profile that deviates from the circular outer profile 64 of the main portion 60 of the retaining member 28. In the embodiment depicted, for example, the two end portions 62 can be formed with an outer profile 68 that generally traces an arc of a circle having a center 70a. As depicted, the outer profile 68 includes a characteristic diameter 70 (and a corresponding radius of curvature) that is smaller than the characteristic diameter 66 of the outer profile of the main portion 60. As can be seen in particular in FIGS. 4A and 4B, this can result in the outer profile 68 of the end portions 62 of the retaining member 28 bending somewhat radially inward from the projected path of the circular outer profile 64 of the main portion 60 of the retaining member 28 (i.e., toward the center 66a of the outer profile 64). As discussed in greater detail below, this deviation of the outer profile 68 of the end portions 62 from the outer profile 64 of the main portion 60 can allow for relatively easy and secure installation of the retaining members into the retaining groove 44.

In certain embodiments, the center 70a of the outer profile 68 can be offset from the center 66 towards the main portion 60 of the retaining member 28a, and the ends 62a of the end portions 62 can extend circumferentially past the characteristic diameter 70. Accordingly, the ends 62a of the end portions 62 can be generally removed (e.g., offset circumferentially) from the radially outermost points 68a (or portion) of the end portions 62. In certain embodiments, the offset of the center 70a from the center 66a can be between 5 mm and 10 mm.

In certain embodiments the outer profile of the end portions 62 of the retaining members 28 can deviate from the outer profile 64 of the main portion 60 of the retaining members 28, while exhibiting a non-circular or only partially circular profile. For example, rather than (or in addition to) the depicted circular profile 68, the outer profile of the end portions 62 can exhibit a linear profile 76 (see FIG. 4B), that generally deviates from outer profile 64 of the main portion 60 towards the center 66a of the profile 64. In certain embodiments, other configurations may also be possible. For example, a stepped, partially linear and partially circular, or other profile (not shown) can be used for the outer profile 68 of the end portions 62.

In certain embodiments, an inner profile 76 of the entire retaining member 28 can exhibit a generally circular profile, with a characteristic diameter (not shown) that is generally smaller than the characteristic diameters 66 and 70 of the main portion 60 and end portions 62, respectively, of the retaining member 28. Accordingly, the retaining member 28 can exhibit a width 74 along the main portion 60 (e.g., between 10 mm and 20 mm) that is somewhat larger than a width 78 (e.g., a variable width) along the end portions 62. In certain embodiments, a thickness 72 can be relatively constant over the entire retaining member 28. In certain embodiments, the thickness 72 can be slightly smaller than the width 44a of the retaining groove 44 (see, e.g., FIG. 2B), such that the retaining members 28 can be easily inserted into the groove 44. The width 78 and the widths 74 and 76 can be selected, in certain embodiments, in order to ensure appropriate strength for the retaining members 28 (e.g., to withstand appropriate levels of shear, as imposed by the end cap 26 and the retaining groove 44), or based on various other considerations.

The retaining members 28 can be formed from a variety of materials, using a variety of known manufacturing techniques. In certain embodiments, relatively rigid material (e.g., steel) can be used in order to provide appropriate strength for the retaining members 28. As appropriate, based upon the needs of the particular pressure vessel, other materials may additionally (or alternatively) be used. For example, for relatively low-pressure (or other) applications, plastic or polymer retaining members 28 can be used.

Only one of the retaining members 28 is depicted in FIGS. 4A through 4C. In certain embodiments, each retaining member 28 of the closure apparatus 20 can be configured with matching geometry and dimensions (e.g., both as depicted in FIGS. 4A through 4C). In certain embodiments, various retaining members 28 can be configured differently from each other in various ways (e.g., in the outer profiles 68 of the end portions 62 of the retaining members 28, and so on).

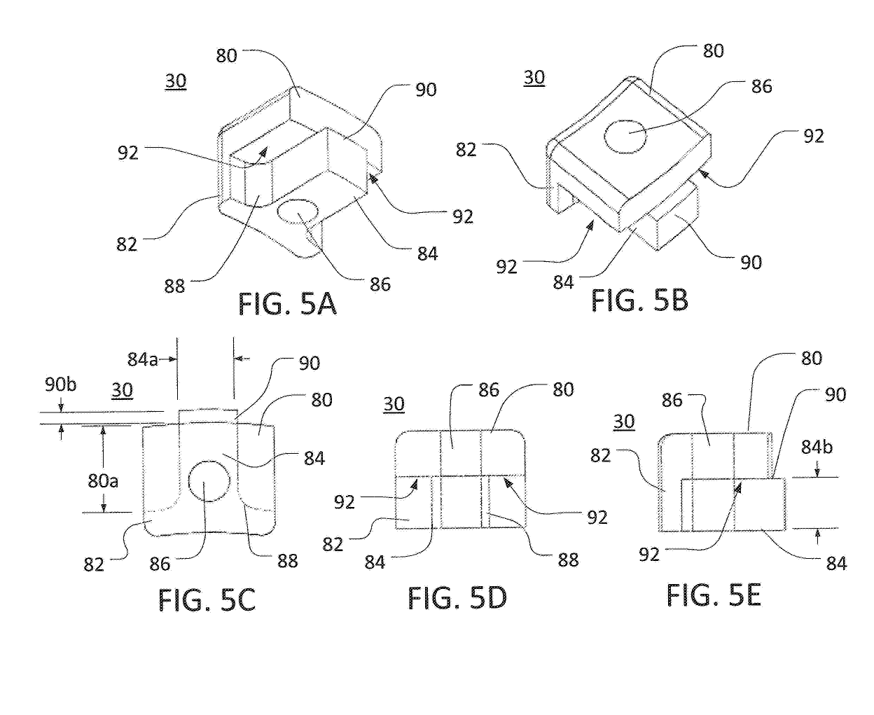

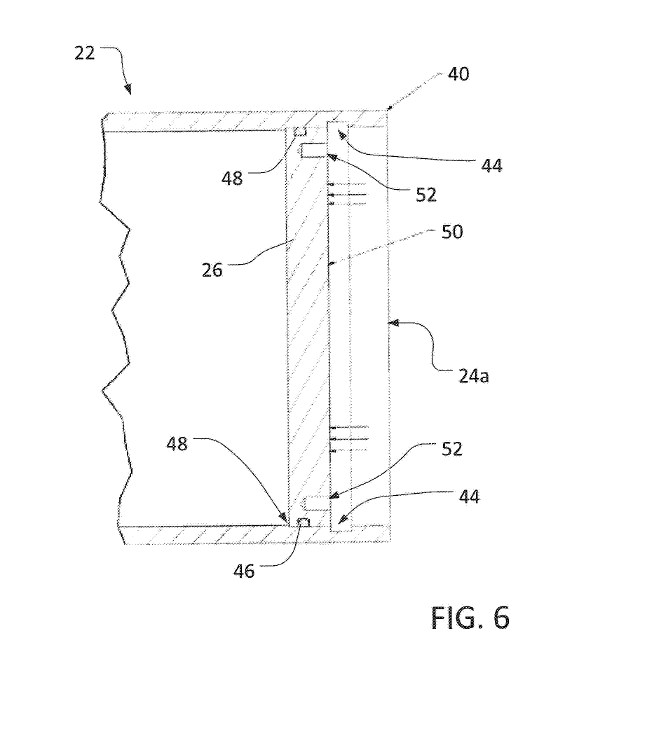

Referring also to FIGS. 5A through 5E, one of the stops 30 is depicted from various perspectives. As also noted above, the stop 30 can generally secure the retaining members 28 in place within the retaining groove 44 such that the retaining members 28 can secure the end cap 26 within the shell 24. In the embodiment depicted, each stop 30 can include a cap portion 80, inner surfaces 92 of which can face the retaining members 28 when the closure apparatus 20 is installed. An end portion 82 and a tongue 84 can extend away from the cap portion 80, with a lip 90 of the tongue 84 extending radially outward (e.g., upward in FIG. 6C) past an edge of the cap portion 80. In certain embodiments, a width 84a of the tongue 84 (see FIG. 6C) can be generally smaller than the a width of the end portion 82. Similarly, a depth 84b of the tongue 84 (e.g., at the lip 90) can be generally similar to the width of the retaining groove 44a and, accordingly, can be generally similar to the thickness 72 of the retaining members 28 (see FIG. 4C). A fillet 88 (or other geometry) can be provided between the end portion 82 and the tongue (or between various other features of the stop 30). An attachment device, such as a bore 86 configured to receive a pin or bolt (see FIG. 1), can extend through the cap portion 80 and the tongue 84, or otherwise through the stop 30.

Only one of the stops 30 is depicted in FIGS. 5A through 5C. In certain embodiments, each stop 30 of the closure apparatus 20 can be configured with similar geometry and dimensions. In certain embodiments, various stops 30 can differ from each other in various ways. The stops 30 can be cast, machined, or otherwise formed in various known ways and from various materials, as appropriate for a particular application or pressure vessel.

Referring also to FIGS. 6 through 10, an installation method for the closure apparatus 20 is depicted. (It will be understood that similar methods can be used for other closure apparatuses contemplated by this disclosure.) As depicted in FIG. 6, the end cap 26 can be aligned with and inserted into the open end 24a of the shell 24, until the end cap 26 is seated against the shoulder 48 and the axially outer face 50 of the end cap is aligned with (or inward of) the inner edge of the retaining groove 44.

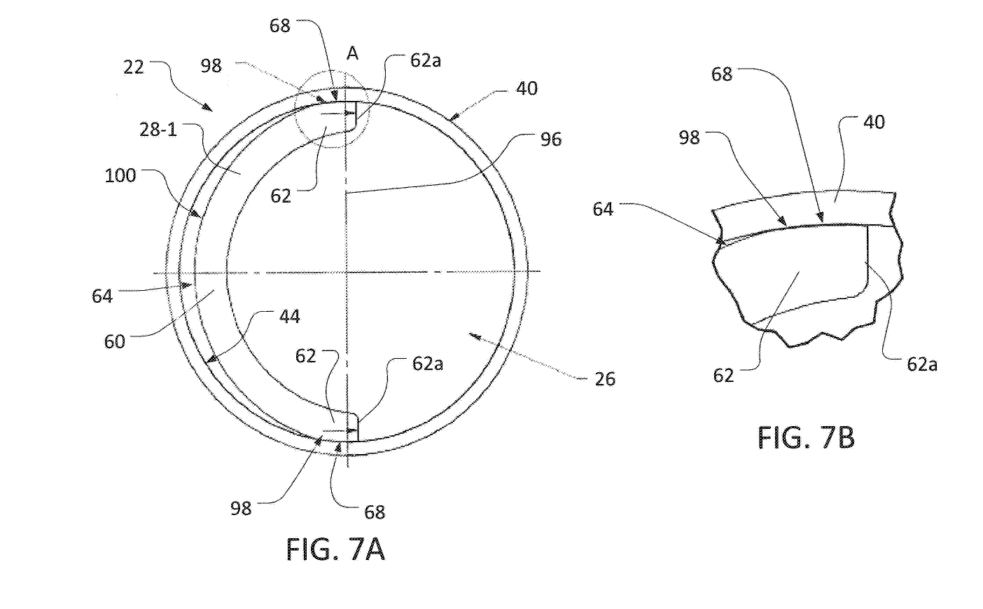

As depicted in FIG. 7A, once the end cap 26 is in place, a first of the retaining members 28 (herein, the retaining member 28-1) can be inserted. As noted above, the main portion 60 of the retaining member 28-1 can exhibit substantially the same characteristic diameter 66 (see FIG. 4B) as the diameter 56 of the retaining groove 44 (see FIG. 2B). Accordingly, in order to align the retaining member 28-1 for insertion into the retaining groove 44, with the retaining member 28-1 seated against (or near) the outer face 50 of the end cap 26, it may be necessary to align the retaining member 28-1 with the ends 62a of the end portions 62 offset to the right (as depicted) of a centerline 96 of the shell 24. This can provide a clearance 100 between the retaining member 28-1 and the inner surface of the wall 40, such that the retaining member 28-1 can be pressed flat against the outer face 50 of the end cap 26 and inserted into the retaining groove 44 without deforming the retaining member 28-1. In certain embodiments, such an offset can be approximately 9 mm, although other configurations may be possible depending on various factors, including the particular geometry of the pressure vessel 22.

Were the circular outer profile 64 of the main portion 60 of the retaining member 28-1 to extend fully to the ends 62a of the end portions 62 of the retaining member, the ends 62a would extend past the inner diameter 34 of the wall 40 (see FIG. 2B) to prevent the alignment of the retaining member 28-1 with the retaining groove 44. As depicted in ?FIG. 7B, however, because the outer profile 68 of the end portions 62 of the retaining member 28-1 deviates radially inward from the circular outer profile 64 of the main portion 60 of the retaining member 28-1, a clearance 98 is preserved between the end portions 62 of the retaining member 28-1 and the inner surface of the wall 40, even with the above-noted offset of the ends 62a from the centerline 96. Accordingly, the deviating outer profile 68 of the end portions 62 can allow alignment of the retaining member 28-1 with the annular groove 44, as required for proper installation of the retaining member 28-1, and insertion of the retaining member 28-1 into the retaining groove 44 without deformation of the retaining member 28-1.

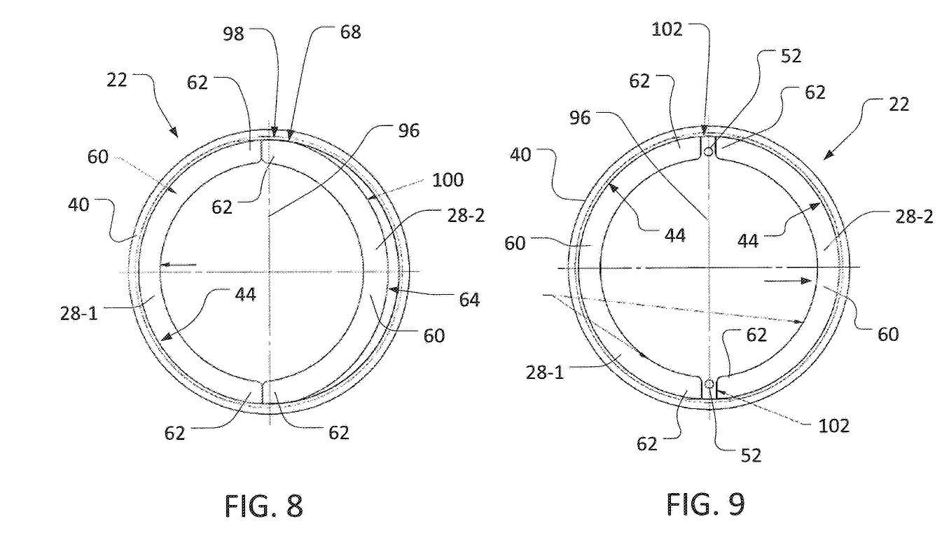

Referring also to FIG. 8, once the retaining member 28-1 is aligned with the retaining groove 44, the retaining member 28-1 can be slid into the groove 44. A second of the retaining members 28 (herein, the retaining member 28-2) can then be similarly installed. For example, as can be seen in FIG. 8, once the retaining member 28-1 has been seated within the retaining groove 44 the ends 62a of the retaining member 28-1 can be sufficiently offset from the centerline 96 (to the left in FIG. 8) that the retaining member 28-2 can be inserted into the pressure vessel 22, as similarly described above for the retaining member 28-1, but on the opposite side of the centerline 96. As depicted in FIG. 9, seating both of the retaining members 28-1 and 28-2 (collectively, herein, “the retaining rings 28”) within the retaining groove 44, a can define a gap 102 between the end portions 62 of the retaining members 28, such that the holes 52 in the end cap 26 are accessible. In certain embodiments, the retaining members 28 can be generally configured such that the gap 102 is approximately equal to (e.g., slightly larger than) the width 84a of the tongue 84 of the stop 30 (see FIG. 5C). In this way, for example, the tongue 84 can be inserted within the gap 102 to engage the retaining groove 44 while also contacting the end cap 26 to provide additional retention force to the end cap 26.

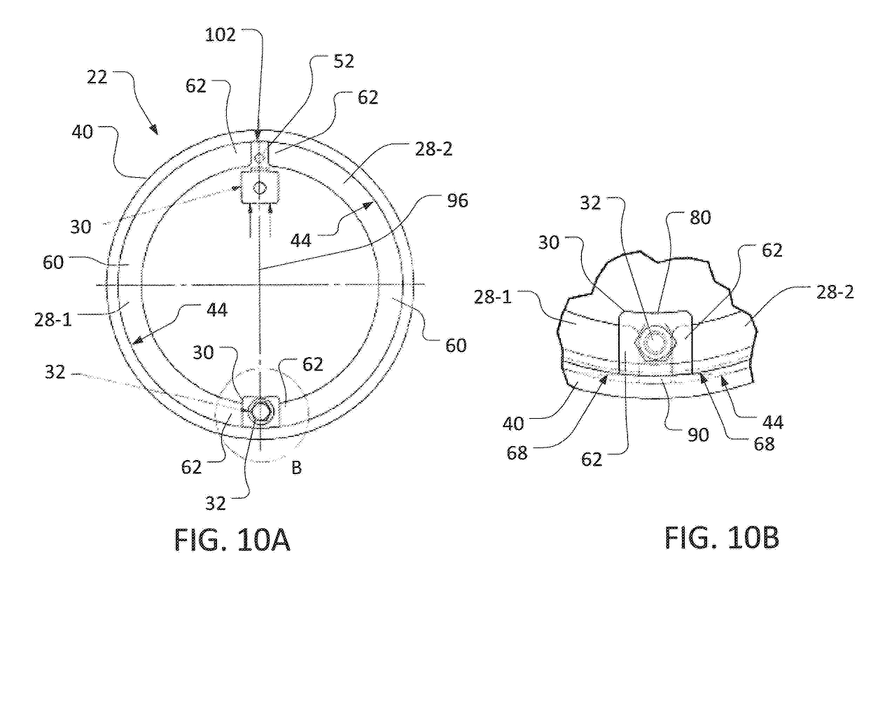

As also noted above, the characteristic diameter 66 of the outer profile 64 of the main portion 60 of the retaining member 28 (see, e.g., FIG. 4B) can be of approximately the same dimension as the diameter 56 of the retaining groove 44 and, accordingly, the outer profile 64 can be generally congruent with a corresponding arc of the retaining groove 44 and the. Accordingly, as can be seen in FIG. 9 (and FIG. 10B), neither retaining member 28 may seat against a full 180 degree arc of the retaining groove 44 when the retaining member 28 is inserted into the retaining groove 44. For example, the retaining members 28 can be configured to extend over approximately 175 degrees of the retaining groove 44, rather than an entire half-circumference. In some embodiments, this can result not only from geometry that results in the gap 102, but also from the deviation of the outer profile 68 of the end portions 62 of the retaining members 28 (see, in particular, FIG. 10B), which can be necessary to allow seating of the retaining members 28 within the retaining groove 44 without deformation of the retaining members 28. However, the relatively large portion of the groove 44 against which the retaining members 28 can be seated can still provide substantial retention strength with regard to the end cap 26. In some embodiments, for example, the retaining members 28 can extend into the retaining groove 44 around 88% or more of the circumference of the retaining groove 44. Further, the stops 30 may provide additional engagement of the retaining groove 44 and the end cap 26, potentially engaging an additional 3% or more of the circumference of the retaining groove 44, for a maximum engagement for the retaining members 28 and the stops 30 of 91% or more.

In contrast, for example, to various circlip designs, the clearance 98 between the end portions 62 of the retaining members 28 and the inner surface of the wall 40, which facilitates insertion of the retaining members 28 into the retaining groove 44, can be achieved without deforming the retaining members 28 from their natural (e.g., un-stressed) configurations. Accordingly, the retaining members 28 can be manufactured to exhibit substantial stiffness for high retention strength, without introducing the need for special tools to insert the retaining members 28 into the retaining groove 44. Further, because the retaining members 28 may not need to be deformed for installation, the potential for improper installation of the retaining members 28 can be further reduced.

Referring also to FIGS. 10A and 10B, with the retaining members 28 seated within the retaining groove 44, the stops 30 can be slid into place, with the tongues 84 extending within the gap 102 such that the lips 90 of the tongues 84 can also be inserted into the groove 44. As noted above, the gap 102 can be approximately equal to the width 84a of the tongue 84 (e.g., can exhibit a width exceeding the width 84a of the tongue by 0.3 mm to 0.5 mm), which can allow the stops 30 to be relatively easily slid into place. Further, in certain embodiments, the gap 102 can help ensure that the stops 30 can be installed only when the retaining members 28 are appropriately seated within the groove 44. As described above, the geometry of the retaining members 28 and the shell 24 can require the retaining members 28 to be offset from the centerline 96 for installation. Accordingly, a appropriately wide gap 102 for installation of the stops 30 can be opened only when the retaining members 28 are appropriately seated within the retaining groove 44.

Once the stops 30 are in place, the bolts 32 (or other fastening devices) can be used to secure the stops 30 to the end cap 26. In certain embodiments, the bolts 32 can be shear bolts, such that the heads of the bolts 32 can shear off once an appropriate torque is reached, which can thereby prevent disassembly of the installed closure apparatus 20 with normal hand tools. In certain embodiments, the stops 30 can be secured in place using various other devices or arrangements. For example, in certain embodiments, the stops 30 can be secured to the wall 40 of the shell 24, rather than to the end cap 26.

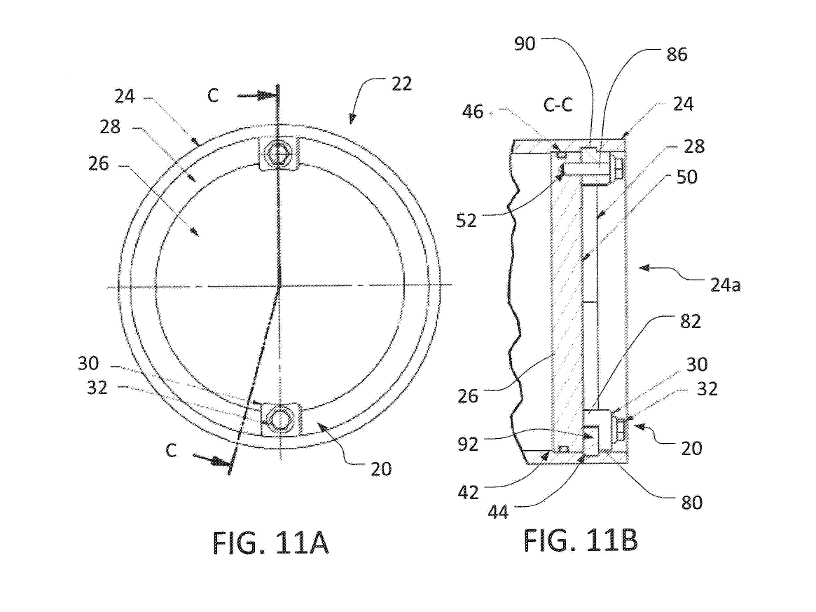

Referring also to FIGS. 10A and 11B, and as also described above, when the end cap 26 is inserted into the open end 24a of the shell 24 the end cap 26 can seat against the shoulder 42, the shoulder 42 thereby preventing further movement of the end cap 26 into the shell 24. The retaining members 28 can then be seated within the groove 44 and secured in place with the stops 30 and the bolts 32. (As also noted above, in some embodiments, different attachment devices may be used to attach the stops 30 to the end cap 26 or to other features, such as the shell 24.) As the pressure vessel 22 is pressurized the pressure can provide a force urging the end cap 26 outward toward the open end 24a of the shell 24. Upon contact with the retaining members 28, however, any further outward movement of the end cap 26 can be arrested by the retaining members 28, which can themselves be prevented from moving outward by the groove 44 (and the stops 30). In this way, the retaining members 28 can ensure the integrity of the pressure vessel 22 up to (and beyond) the rated pressure of the vessel 22.

Referring in particular to FIG. 11B, and as noted above, when the stops 30 are installed, with inner surfaces 92 of the cap portions 80 facing (and contacting) outer surfaces 28a of the retaining members 28, the lips 90 of the respective tongues 84 can extend into the retaining groove 44 between the end portions 62 of the respective retaining members 28. Thus, the lips 90 can themselves resist outward movement of the stops 30 toward the open end 24a of the shell 24. Accordingly, via contact between the stops 30 and the end cap 26, the lips 90 can further enhance the ability of the closure apparatus 20 to secure the end cap 26 within the shell 24. As also noted above, the deviation of the outer profile 68 of the end portions 62 of the retaining members 28 from the outer profile 64 of the main portion 60 of the retaining members can result in less than complete coverage of the circumference of the retaining groove 44 by the retaining members 28 (see, e.g. FIG. 10B). The extension of the lips 90 into the retaining groove 44 can increase the percentage of the retaining groove 44 that is engaged to resist outward movement of the end cap 24, including to 91% or more.

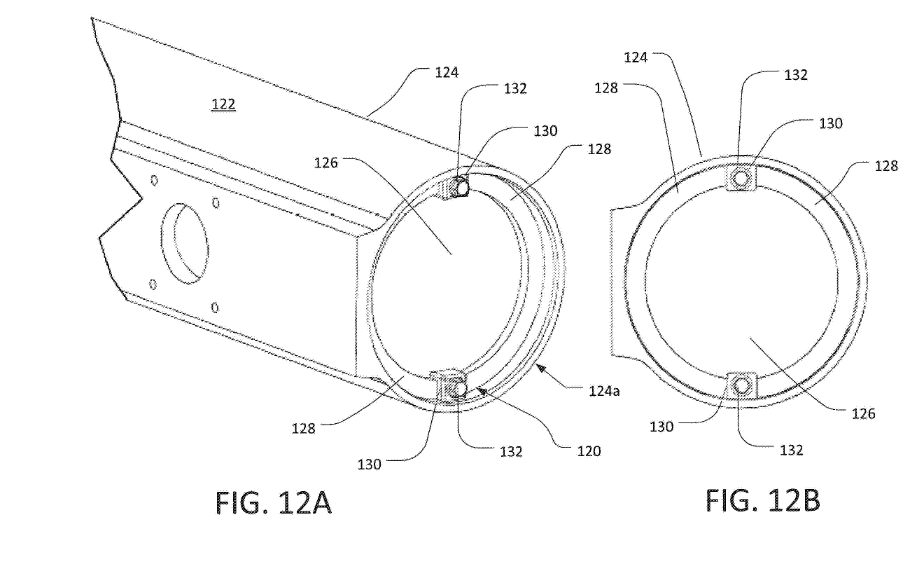

In certain embodiments, the disclosed closure apparatus can be used with pressure vessels having non-cylindrical external surfaces. Referring also to FIGS. 12A and 12B, for example, a closure apparatus 120 can be used with a pressure vessel 122 that includes a pressure vessel shell 124 with a non-cylindrical outer profile. Similar to the closure apparatus 20, the closure apparatus 120 can include a set of two retaining members 128, each exhibiting a generally annular profile over at least a portion of the retaining members 128 and a deviation from a main profile near the ends of the retaining members 128. The retaining members 128 can be seated against the end cap 126 of the pressure vessel 122 and within a generally annular groove (not shown) around the interior of the shell 124. A set of stops 130 can be secured to the end cap 126 (or other feature) by bolts 132 (or various other attachment devices) in order to hold the retaining member 128 in place within the annular groove, such that the end cap 126 is retained in place within the shell 124 by the retaining members 128 (and the stops 130) upon pressurization of the vessel 122.

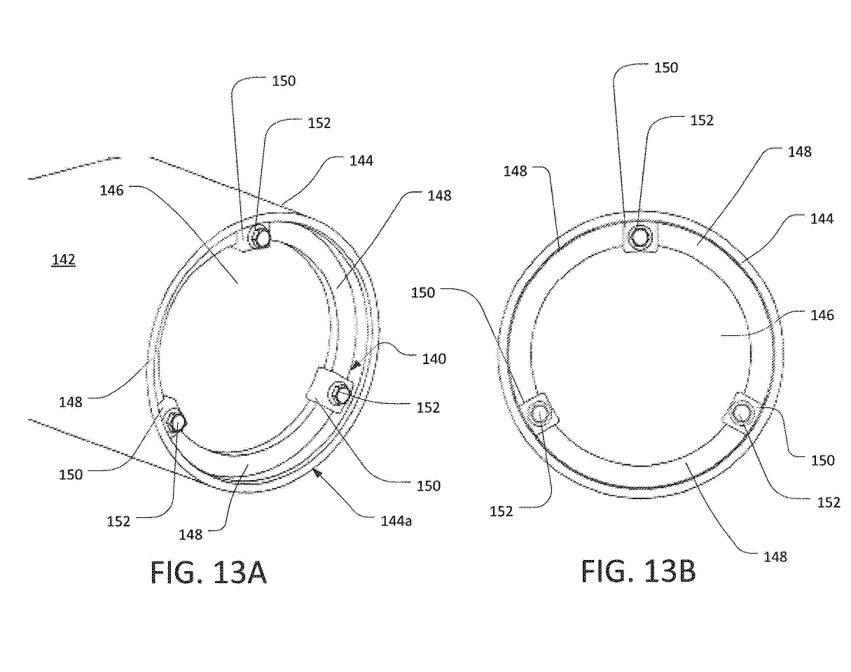

In many applications, use of only two retaining members may result in increased retention strength over other designs, as well as a relatively simple installation process. In certain embodiments, however, more than two retaining members and more than two stops can be provided. Referring also to FIGS. 13A and 13B, for example, a closure apparatus 140 can be used with a pressure vessel 142. The closure apparatus 150 can include a set of three retaining members 148, each exhibiting a generally annular profile over at least a portion of the retaining members 148 and a deviation from a main profile near the ends of the retaining members 148. The retaining members 124 can be seated against the end cap 146 of the pressure vessel 142 and within a generally annular groove (not shown) around the interior of the shell 144. A set of three stops 150 can be secured to the end cap 146 (or other feature) by bolts 152 (or various other attachment devices) in order to hold the retaining member 148 in place within the annular groove, such that the end cap 146 is retained in place within the shell 144 by the retaining members 148 upon pressurization of the vessel 142.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A pressure vessel closure apparatus for a pressure vessel having a shell with a shell wall, a removable end cap, and an internal retaining groove along an interior surface of the shell wall, the pressure vessel closure apparatus comprising:
a first retaining member including a first main portion with a first main-portion outer profile configured for insertion into the retaining groove, the first retaining member further including a first end portion with a first end-portion outer profile, the first end-portion outer profile deviating from the first main-portion outer profile to provide a first clearance between the interior surface of the shell wall and the first retaining member when the first main portion is inserted into the retaining groove;
a second retaining member including a second main portion with a second main-portion outer profile configured for insertion into the retaining groove, the second retaining member further including a second end portion with a second end-portion outer profile, the second end-portion outer profile deviating from the second main-portion outer profile to provide a second clearance between the interior surface of the shell wall and the second retaining member when the second main portion is inserted into the retaining groove; and
a stop configured for insertion between the first and second end portions when the first and second retaining members are inserted into the retaining groove, the stop including an attachment device for securing the stop with respect to at least one of the end cap and the shell wall;
the stop engaging the first and second end portions of the first and second retaining members to retain the first and second retaining member within the retaining groove, when the stop is inserted between the first and second end portions and secured with respect to the at least one of the end cap and the shell wall;
the first and second retaining members, when retained within the retaining groove by the stop, engaging the internal restraining groove and the end cap to retain the end cap within the pressure vessel.

2. The pressure vessel closure apparatus of claim 1, wherein at least one of the first and second main-portion outer profiles includes a first arc with a first radius of curvature; and
wherein at least one of the first and second end-portion outer profiles includes a second arc with a second radius of curvature smaller than the first radius of curvature.

3. The pressure vessel closure apparatus of claim 2, wherein a center of the second radius of curvature is offset, from a center of the first radius of curvature, towards the at least one of the first and second main-portion outer profiles.

4. The pressure vessel closure apparatus of claim 1, wherein at least one of the first and second main-portion outer profiles connects, respectively, to at least one of the first and second end-portion outer profiles.

5. The pressure vessel closure apparatus of claim 1, wherein the stop includes a tongue configured to extend into the retaining groove when the stop is inserted between the first and second end portions, such that the tongue engages the retaining groove to retain the end cap within the pressure vessel when the stop is secured with respect to the at least one of the end cap and the shell wall.

6. The pressure vessel closure apparatus of claim 5, wherein, when the stop is inserted between the first and second end portions, the tongue is disposed between the first and second end portions.

7. The pressure vessel closure apparatus of claim 6, wherein, when the tongue is disposed between the first and second end portions, the tongue contacts the end cap to retain the end cap within the pressure vessel.

8. The pressure vessel closure apparatus of claim 1, wherein the stop includes a cap portion configured to engage first and second surfaces of the first and second retaining members, respectively.

9. The pressure vessel closure apparatus of claim 8, wherein a tongue of the stop extends away from the cap portion towards the end cap, such that the tongue is disposed between the first and second end portions, when the stop is inserted between the first and second end portions.

10. The pressure vessel of claim 9, wherein the tongue includes a lip portion extending radially outward of the cap portion to engage the retaining groove, when the stop is inserted between the first and second end portions.

11. The pressure vessel closure apparatus of claim 1, wherein the first retaining member includes a third end portion opposite the first end portion, the third end portion including a third end-portion outer profile that deviates from the first main-portion outer profile to provide a third clearance between the interior surface of the shell wall and the first retaining member when the first main portion is inserted into the retaining groove;
wherein the second retaining member includes a fourth end portion opposite the second end portion, the fourth end portion including a fourth end-portion outer profile that deviates from the second main-portion outer profile to provide a fourth clearance between the interior surface of the shell wall and the second retaining member when the second main portion is inserted into the retaining groove;
wherein the pressure vessel closure apparatus further includes a second stop configured for insertion between the third and fourth end portions when the first and second retaining members are inserted into the retaining groove, the second stop including a second attachment device for securing the second stop with respect to at least one of the end cap and the shell wall; and
wherein, when the second stop is inserted between the third and fourth end portions and secured with respect to the at least one of the end cap and the shell wall, the second stop engages the third and other fourth end portions to retain the first and second retaining member within the retaining groove.

12. The pressure vessel closure apparatus of claim 1, wherein the first and second main-portion outer profiles are substantially congruent with a radially outer circumference of the retaining groove.

13. The pressure vessel closure apparatus of claim 1, further comprising:
a third retaining member including a third main portion with a third main-portion outer profile configured for insertion into the retaining groove, the third retaining member further including a third end portion with a third end-portion outer profile, the third end-portion outer profile deviating from the third main-portion outer profile to provide a third clearance between the interior surface of the shell wall and the third retaining member when the third main portion is inserted into the retaining groove; and
a second stop including an attachment device for securing the stop with respect to at least one of the end cap and the shell wall;
wherein the first retaining member includes a fourth end portion with a fourth end-portion outer profile, the fourth end-portion outer profile deviating from first main-portion outer profile to provide a fourth clearance between the interior surface of the shell wall and the fourth retaining member; and
wherein the second stop is configured for insertion between the third and fourth end portions, when the first and third retaining members are inserted into the retaining groove, to retain the first and third retaining members within the retaining grove.

14. A pressure vessel closure apparatus for a pressure vessel having a shell with a shell wall, a removable end cap, and an retaining groove along an interior surface of the shell wall, the pressure vessel closure apparatus comprising:
a first retaining member including a first main portion with a first main-portion outer profile, the first retaining member further including first and second end portions at opposite ends of the first outer profile, the first and second end portions having first and second end-portion outer profiles, respectively, that deviate from the first main-portion outer profile;
a second retaining member including a second main portion with a second main-portion outer profile, the second retaining member further including third and fourth end portions at opposite ends of the second outer profile, the third and fourth end portions having third and fourth end-portion outer profiles, respectively, that deviate from the second outer profile; and
first and second stops configured to attach to at least one of the shell wall and the end cap;
the first and second retaining members defining a first gap between the first and third end portions and a second gap between the second and fourth end portions, when the first and second main portions are inserted into the retaining groove; and
the first and second stops securing the first and second retaining members within the retaining groove, when the first and second stops are inserted into the first and second gaps, respectively, and attached to the at least one of the shell wall and the end cap.

15. The pressure vessel closure apparatus of claim 14, wherein the first and second main-portion outer profiles are configured as circular profiles with a first characteristic diameter; and
wherein the first, second, third, and fourth end-portion outer profiles are configured as circular profiles with a second characteristic diameter that is smaller than the first characteristic diameter.

16. The pressure vessel closure apparatus of claim 15, wherein the first and third end-portion outer profiles share a first center of curvature, the first center of curvature being offset from a second center of curvature of the first main-portion outer profile; and
wherein the second and fourth end-portion outer profiles share a third center of curvature, the third center of curvature being offset from a fourth center of curvature of the first main-portion outer profile.

17. The pressure vessel closure apparatus of claim 14, wherein the first and second stops include first and second tongues, respectively, configured to extend into the retaining groove when the first and second stops are inserted, respectively, into the first and second gaps, the first and second tongues engaging the retaining groove to retain the end cap within the pressure vessel.

18. The pressure vessel closure apparatus of claim 17, wherein the first and second tongues are disposed, respectively, within the first and second gaps, when the first and second stops are inserted, respectively, into the first and second gaps.

19. The pressure vessel closure apparatus of claim 18, wherein the first and second tongues contact the end cap to retain the end cap within the pressure vessel, when the first and second tongues are disposed, respectively, within the first and second gaps.

20. A method for installing a pressure closure apparatus for a pressure vessel having a removable end cap, a shell with a shell wall, an open end, and an internal shoulder, and an internal retaining groove along an interior surface of the shell wall, the method comprising:
inserting the end cap into the open end of the shell until the end cap is seated against the internal shoulder, with an outer face of the end cap opposite the retaining groove from the open end;
inserting a first main-portion outer profile of a first retaining member into the retaining groove such that first end-portion outer profiles of the first retaining member are disposed outside the retaining groove to define first clearances between the shell wall and the first retaining member, and such that first and second ends of the first end-portion outer profiles are offset from a centerline of the end cap towards the first main-portion outer profile;
inserting a second main-portion outer profile of a second retaining member into the retaining groove such that second end-portion outer profiles of the second retaining member are disposed outside the retaining groove to define second clearances between the shell wall and the second retaining member, and such that third and fourth ends of the second end-portion outer profiles are offset from the centerline of the end cap towards the second main-portion outer profile,
inserting a first stop between the first end of the first end-portion outer profile and the third end of the second end-portion outer profile, with a first tongue of the first stop extending into the retaining groove;
inserting a second stop between the second end of the first end-portion outer profile and the fourth end of the second end-portion outer profile, with a second tongue of the second stop extending into the retaining groove; and
securing the first and second stops to at least one of the shell wall and the end cap to secure the first and second retaining members within the retaining groove.
